(19) United States
(12) Patent Application Publication
(10) Pub. No.: US 2012/0280069 A1
(43) Pub. Date: Nov. 8, 2012

(54) Method and apparatus for increasing the surface area of a milled product

(76) Inventor: Clinton Wesley Pike, SR., Montgomery, TX (US)

(21) Appl. No.: 13/068,255

(22) Filed: May 6, 2011

(51) Int. Cl. B02C 17/14

(52) U.S. Cl. 241/25; 241/170

(57) ABSTRACT

Increased surface area for a milled product is provided by modifying a standard vibrating media mill for a bottom feedstock feed instead of a top feed, and by replacing the front discharge grate with a solid disk having a slot or slots in the upper region thereof to increase dwell time. In one embodiment, ceramic media replaces the traditional depleted metal ball media.

### FIELD OF THE INVENTION

This invention relates to vibrating milling machines and more particularly to a system for increasing the dwell time in the milling machine for increasing the surface area of the milled product.

### BACKGROUND OF THE INVENTION

Ball milling machines and the like have been utilized in the past to grind fly ash and other pozzolans into a fine powder such that when it is blended with cement the resulting concrete has the required strength and workability characteristics, with the fly ash serving to reduce the overall price of the cementitious mixture by replacing cement with a less expensive filler.

In order to achieve a good quality concrete, it is important that the fly ash replacement for Portland cement not degrade the properties of concrete formed from the mixture.

While it is indeed possible to make concrete from Portland cement alone, the adding of fly ash results in an overall savings, assuming that the amount of fly ash does not adversely affect strength or workability over a one day, a seven day, a fourteen day or a twenty-eight day period. In an attempt to provide an inexpensive concrete, typically in the industry Class F fly ash typically replaces 15% to 25% of the total cementitious mixture and Class C fly ash 20-25%.

When the fly ash is milled in a typical vibrating ball milling machine there are a number of problems most having to do with the strength, durability and workability of the concrete formed from the fly ash cement mixture. These problems increase when one seeks to replace 50% of the cement with the fly ash when, for instance trying to obtain a typical strength of for instance 3000 PSI. The desideratum is that after 7 days one would like to see a strength of 1800 PSI for such a mix with high slumps or water to cement ratios that are around 0.50 or higher. However, up into the present time such has not been possible when trying to replace 50% of the cement with fly ash.

One of the challenges in the use of fly ash is to provide a 50% replacement which performs much like slag. With prior milling machines it was only with great difficulty that one could obtain a grade 80 slag equivalent. Note prior attempts were made to use 1polycarboxylate as an additive but the addition did not result in satisfactory strength unless the additive rate went high which was not economical.

It is noted that in order to make concrete one can simply mix cement, water and aggregates. However, by using an additive such as fly ash one can provide an environmentally-friendly process because its use does not involve the high carbon dioxide emissions associated with cement manufacture. The second advantage of using fly ash is that one obtains a more durable concrete than is possible with for instance Type 1 Portland cement. The third advantage to utilizing fly ash is in terms of workability of the concrete made from the fly ash cement combination.

Thus if it were possible, replacing a significant portion of Portland cement with fly ash not only reduces the cost but is also environmentally-friendly and results in a more durable concrete with better workability up until the present invention no satisfactory results have been obtained.

To summarize, milling fly ash to a fine state that is suitable for combining with cement has heretofore resulted in concrete which has fairly low strength. Even replacing only 20% of the cement with fly ash can result in poor concrete strengths at various ages.

It was thought that one of the problems with the traditional vibrating ball milling of fly ash was that the surface area of the milled fly ash was not sufficiently high. With an increased surface area one has increased activation which in turn improves concrete properties.

One of the reasons for the surface area insufficiency for the fly ash particles is that typically in a vibrating ball milling machine as purchased from the manufacturer the fly ash particles reside in the milling machine for no more than 5 seconds prior to being discharged. The reason for the 5 second dwell time is that product that falls in from the top of the mill to hit the vibrating media, instead of falling down through the media where it is impacted by the media, it floats across the top of the milling machine with very little interaction with the media and then exits the milling machine without spending a significant amount of time in contact with the vibrating media in the mill. The result is insufficiently activated particles.

### SUMMARY OF INVENTION

In order to improve the quality of the resulting concrete it is one purpose of the subject invention to provide milled fly ash or pozzolan with an increased surface area which results in better reactivity and therefore stronger concretes. In order to provide for the increased surface area, rather than feeding raw material into the top of a vibrating ball milling machine, in the subject invention the raw material is fed to the bottom of the milling machine where it is immediately impacted by the media. In one embodiment ceramic media is used, as opposed to metal balls.

Secondly, the residence time in the media is extended by replacing the normal front discharge grate at which the milled material exits the mill with a solid plate having one to three slots at the top of the plate. The result is that the fly ash continues to be milled until only the finest milled product rises up to the slot or slots at the top of the slotted plate. The less finely milled product is forced back into the mill where it is reground until such time as the fly ash particles are more finely ground and rise up to the slot.

In so doing, it has been found that the surface area of the milled product increases by over 20%. The result of the increase in surface area means that one can utilize the milled product as a 50% cement replacement so that one obtains sufficient early age strength even with a 50% cement replacement.

Thus with Class F fly ash, it has been found that rather than being limited to 15% to 25% replacement, one can proceed with a 50% replacement and yet achieve performance similar to that of slag. It will be noted that the above advantages of an environmentally-friendly process that results in adequate strength, and a more durable concrete with better workability is now possible with a 50% concrete replacement. The result in one embodiment is close to a 20% cost savings.

The bottom feed, limited aperture front discharge grate system increases the dwell time of the mixture from 5 seconds to over a minute.

In addition to the bottom feed, limited aperture discharge grate modification to a standard vibrating media mill, it has been found that ceramic media provides a number of distinct advantages for any vibrating mill application. In one embodiment, the ceramic media is in the form of a solid cylinder. This cylindrically shaped ceramic media replaces depleted ball bearings, usually solid one inch or larger metal ball bearings.

It is noted that if one utilizes the aforementioned depleted ball bearings one can only fill a typical mill with weight limits around 1880 to 2000 lbs of media to around 25% of the area of the cavity of the mill. The reason that the mill cannot be filled further is that it would be overloaded. By using a ceramic media which is considerably lighter one can fill the mill up to just under the center spacer without overloading the machine, thus increasing capacity to around 50% of the mill cavity. It is noted that the total weight of ceramic media used is equivalent in weight to the total weight of the metal balls.

As will be appreciated, the weight involved with the ceramic media is about 40% of that associated with metal ball bearings so that one is getting almost two times more media for the same weight. This in turn provides more contact points or impact points in the mill for more efficient milling, regardless of whether it is a top feed mill or a bottom feed mill. It was determined that a mixture of ceramic media acted better than using all one size so as media wears it is left in the mill until it reaches less than ½ in diameter, after which it is removed.

In its simplest embodiment, the original front discharge grate is replaced with a slotted solid disk having a single upper vertically rising slot. Note the only place where material can leave the mill is at this slot. In one embodiment the slot size is 6 square inches, with the discharge slot being above the center spacer. Having the slot in the upper portion of the front discharge disk increases the dwell time of the milled material such that it must rise above the center spacer in order to be discharged at all. Thus, in one embodiment, the front discharge grate is in the form of a solid plate cut with a hole or slot having a 6 square inch slot size. The purpose of utilizing the limited aperture slot is to keep the material in the mill longer so that it impacts the media longer, whereupon it is ground down finer than previously possible.

In a preferred embodiment, rather than utilizing a single slot three slots are provided, with one slot at the 11 o'clock position being 3½ inches long by ¼ inch wide, whereas a second slot at the 12 o'clock position is a 6 inch slot with a ¼ inch width, followed by a third 3½ inch slot with a ¼ inch width at the 1 o'clock position. Alternatively, a variable aperture slot may be utilized.

It is noted that when one begins to keep the material in the mill longer the mill starts to heat up. This results in amperage issues with respect to the mill and the motors that are utilized so that one has to correlate the feed rate and slot size to the power utilized, so that one can increase the productivity of the mill without affecting final product properties while utilizing the same horse power driving the motors. Increasing the horsepower of the drive motors allows more through put to occur.

Note that in one embodiment the surface areas measured by a laser diffractometer increased from for instance an SSA of 34,835 to 42,229. Moreover, it has been found on one occasion that the raw ash at an SSA of 43,166 leaves the mill with a specific surface area of 68,721.

It has also been found that, the residence time in the mill increased from 5 seconds to 1 minute and 10 seconds and even 1 minute and 45 seconds, with the increased milling time increasing the surface area. Note that during experimentation, the more original front discharge grate slots that were closed off, the higher the retention time, results in a concomitant increases in surface area that resulted in better product strength.

Finally, with aperture sizes on the order of 6 to 9 square inches one can obtain consistent type of material coming out of the mill. While it is indeed true that mill energy costs are much lower when the milled material spends only 5 seconds in the mill, the results were unacceptable. However, by closing down the exit aperture to achieve increased dwell time one achieves substantially superior performance with controllable energy costs.

In one embodiment, the discharge disk has a central hub through which the center spacer protrudes, thus aligning the front discharge disk with the center of the mill.

Moreover, it is noted that the slot acts as a place to funnel the material and therefore the slot acts as a classifier such that only the material that has been vibrated sufficiently to the correct vibrational frequency, which typically runs at 1170 to 1190 vibrations a minute as the mill is set up from the manufacturer, and will have the appropriate surface area when it leaves the mill, with the lighter finer material exiting first. The material that has not exited stays in the mill a little longer until it is more finely divided, after which it leaves. Thus, the milled material is blocked until it is fine enough to exit through the slot or slots provided. The result is that the particles that exit the mill have an increased surface area, with the milled particles that do not exit being retained in the mill until they become fine enough.

It is noted that in the preferred embodiment fly ash or pozzolan is milled first and then mixed with cement. It has been found that it is not necessary or desirable to mill cement and fly ash together. It is only necessary that the fly ash or pozzolan have sufficient surface area to provide activation either through the contact with cement, when mixed with it, or where the Calcium Oxide given off by the cement readily reacts with the amorphous Silica to form the cementitious type of strength crystals found in Portland cement. Also, the increased surface area of the milled fly ash now reacts much quicker and is aided by the addition of polycarboxylate water reducers, or accelerators used in the concrete industry or combinations of such either at the end users site or as an after processing blend additive.

The mill in one embodiment is a METSO VBM vibrating ball mill model 3034 modified to admit raw material into the bottom of the mill and having its front discharge grate modified into a solid plate with a single upper exit slot, thereby keeping the milled material in the mill for longer periods of time than heretofore possible, with the result that the milled particles have increased reactive surface area which in turn permits a 50% fly ash replacement strategy that gives acceptable early strengths in concrete applications. Note multiple upper exit slots or increased apertures in the top of the solid front discharge grate are within the scope of the invention.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of a typical vibrating ball mill indicating a top feed and milled product exiting from the front discharge grate;

FIG. 2 is a cross sectional and diagrammatic illustration of the vibrating ball mill of FIG. 1 modified to show a bottom fill for fly ash which proceeds through the vibrating media of the mill to an upper area when light enough where it exits a slot in a solid front discharge disk;

FIG. 3 is a diagrammatic illustration of the slotted front discharge disk of FIG. 2 illustrating a number of upper slots in the solid disk;

FIG. 4 is a diagrammatic illustration of a portion of the slotted front discharge disk of FIG. 3 illustrating the placement of the slots above a central hub; and,

FIGS. 5-9 are mill records for mills 2-6 describing the orientation and size of the slots in the front discharge disk, also illustrating the weight of the media, the feed rate, the amps at the feed rate, the retention time, the particle size distribution and the specific surface area relating to the raw ash and the milled material.

### DETAILED DESCRIPTION

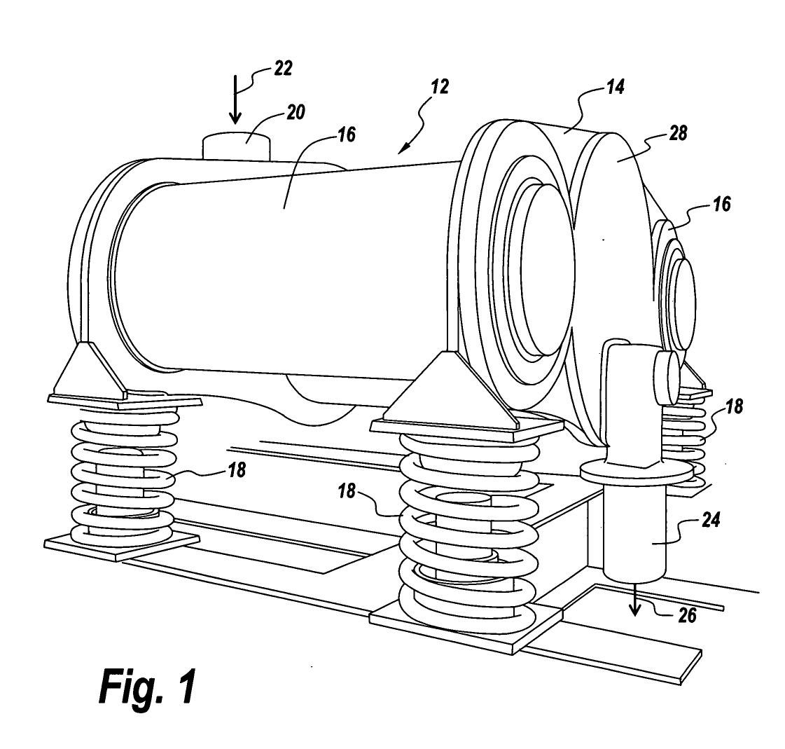

Referring to FIG. 1, a vibrating media Mill 12 is shown having a chamber 14 which houses the vibrating media. Also shown are side actuators 16 which cause chamber 14 to vibrate on springs 18 to mill the material fed into the chamber.

As shown, a top feed 20 is fed with feedstock to be milled as illustrated by arrow 22, with the milled material exiting at an exit port 24 as illustrated by arrow 26.

In this conventional vibrating mill the media utilized are depleted ball bearings which impact the material during the vibration. The vibration pulverizes the feedstock to a point where it exits through a front discharge grate behind door 28, with the front discharge grate having a multiplicity of slots or apertures therein throughout the entire extent of the grate.

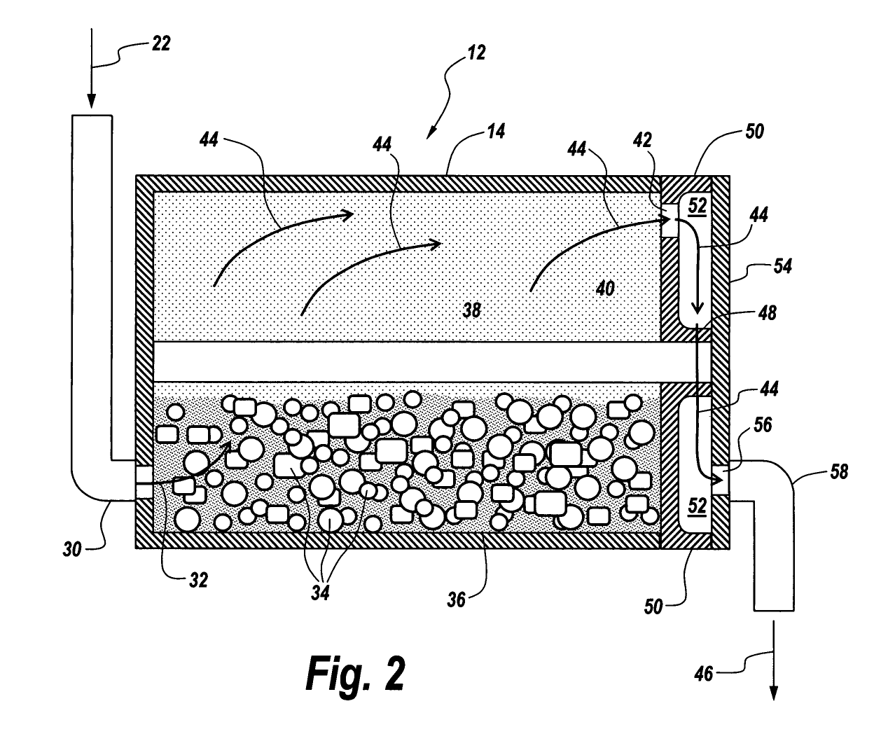

As shown in FIG. 2, the vibrating media Mill 12 is modified such that a bottom feed conduit 30 feeds feedstock 22 to the bottom of vibrating chamber 14 where it enters chamber 14 as illustrated by arrow 32.

In one embodiment the media utilized is a ceramic media here illustrated at 34 which in a preferred embodiment fills the chamber from the bottom 36 to the center spacer 38. As a result, a larger contact area within chamber 14 is provided.

As can be seen, a slotted solid front discharge disk 40 is substituted for the front discharge grate that is normally utilized, with the front discharge disk having a slotted aperture 42 through which the light highly refined milled feedstock exits as illustrated at arrows 44 such that the milled material exits as shown at 46. It is noted that disk 40 has a central hub 48 through which the center spacer protrudes.

Also, as can be seen, disk 40 is provided with an integral lip 50 as well as integral hub 48, thereby defining a cavity 52 between disk 40 and an end plate 54. End plate 54 is provided with an aperture 56 which communicates with a discharge pipe 58 such that the milled material exits chamber 14.

As described above, the only exit aperture or slit is well above the center of the chamber as defined by the central spacer. If the milled material is not sufficiently small in size or light enough to exit slot 42 it is returned back into the chamber where it is re-milled until it rises to slot 42 at which point it exits.

It will be appreciated that having an exit slot or aperture at the top of chamber 14 increases the dwell time of the feedstock in the chamber where it is continuously ground to finer and finer degrees, with slot 42 in one embodiment providing a classifier that only passes certain size milled material to exit pipe 58. As has been explained hereinbefore, rather than having a dwell time of a mere 5 seconds, in the subject invention as much as a minute 45 seconds of dwell time has been achieved given proper feed rates and slot sizes.

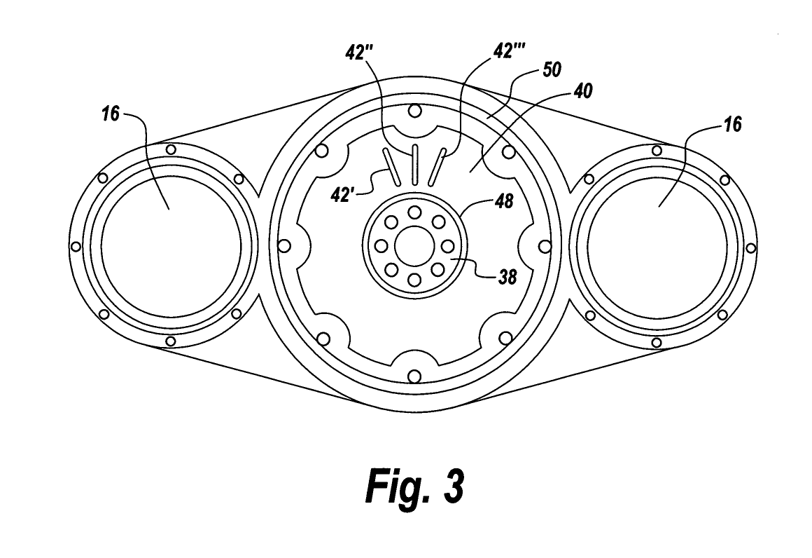

Referring to FIG. 3, a diagrammatic illustration of slotted disk 40 of FIG. 2 shows three slots in the disk. It will be appreciated this disk with lip 50 is clamped into place at the front end of chamber 14 with central spacer 38 protruding through hub 48.

Here the configuration shown is a three slot configuration with a first slot 42′ at the 11 o'clock position, a vertical slot 42″ at the 12 o'clock position, and a slot 42′″ at the 1 o'clock position.

In one embodiment slots 42′ and 42′″ are 3½ inches long and have a width of ¼ inch, whereas slot 42″ is a 6 inch slot with a one ¼ width.

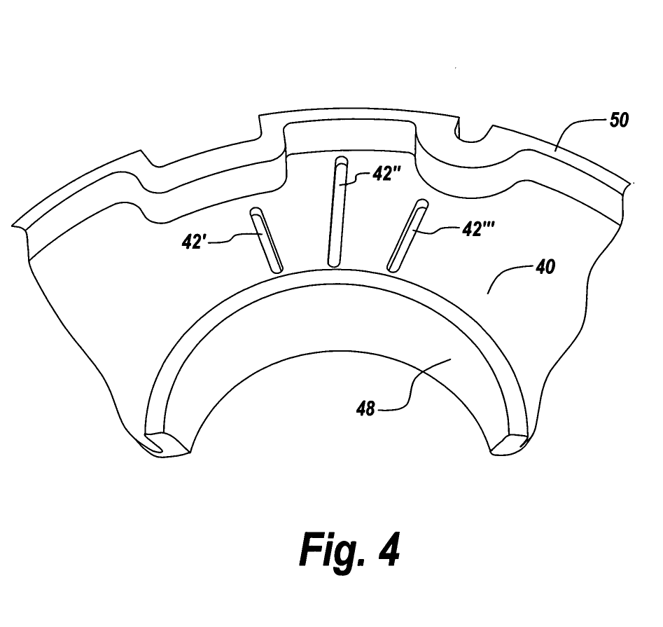

A portion of disk 40 is shown in FIG. 4 with slots 42′, 42″ and 42′″ clearly indicated. Also integral rim 50 and hub 48 are clearly shown.

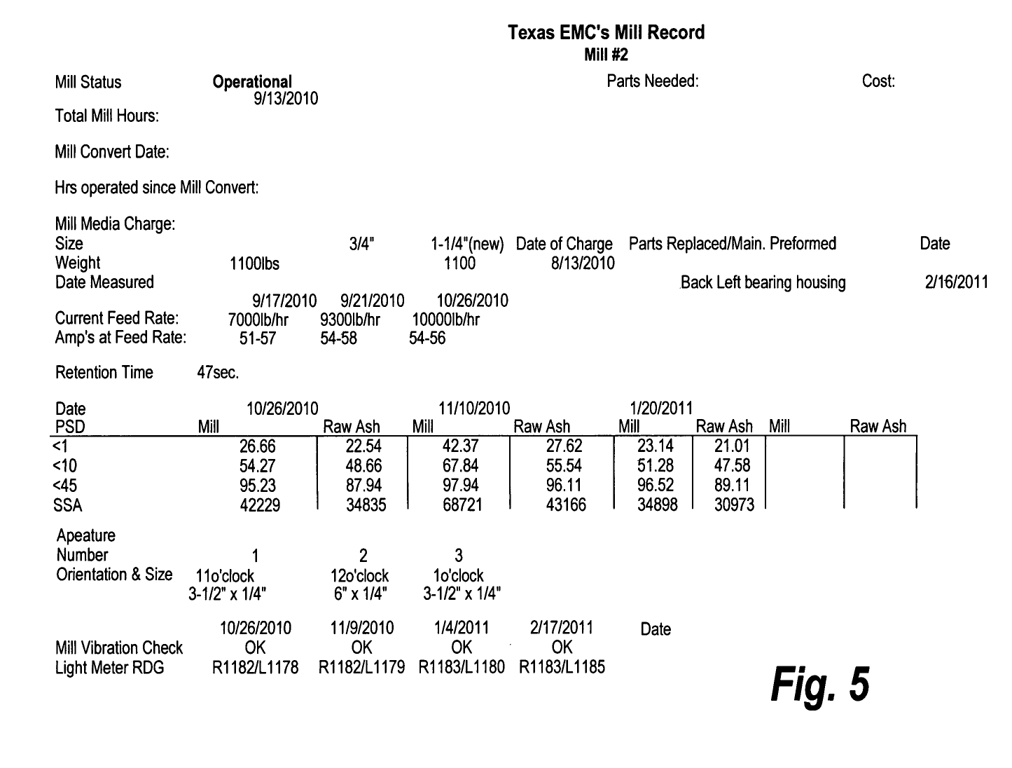

Referring now to FIGS. 5-9, what is shown are the mill records for mills 2-6, each operating with the indicated mill media charge in terms of weight, the current feed rate, the amps at the a particular feed rate, the retention time, the particle size distribution and the specific surface area for raw ash and milled product.

In FIG. 5 with respect to Mill 2, the configuration of FIG. 3 is shown in which there are slots 1, 2 and 3 at the respective 11 o'clock, 12 o'clock and 1 o'clock positions, with the sizes respectively of 3½ inches long by one ¼ inch wide, 6 inches long by one ¼ inch wide, and 3 inches long by one ¼ inch wide.

It will be seen that the specific surface area (SSA) has increased from the raw ash in one instance from 34,835 to 42,229 as measured by a laser scattering particle size distribution analyzer LA 300. As can be seen in a second test, the raw ash SSA went from 43,166 to 68,721 and in a third test from 30,973 to 34,898.

Here the retention time was 47 seconds as opposed to for instance 5 seconds in an unmodified mill.

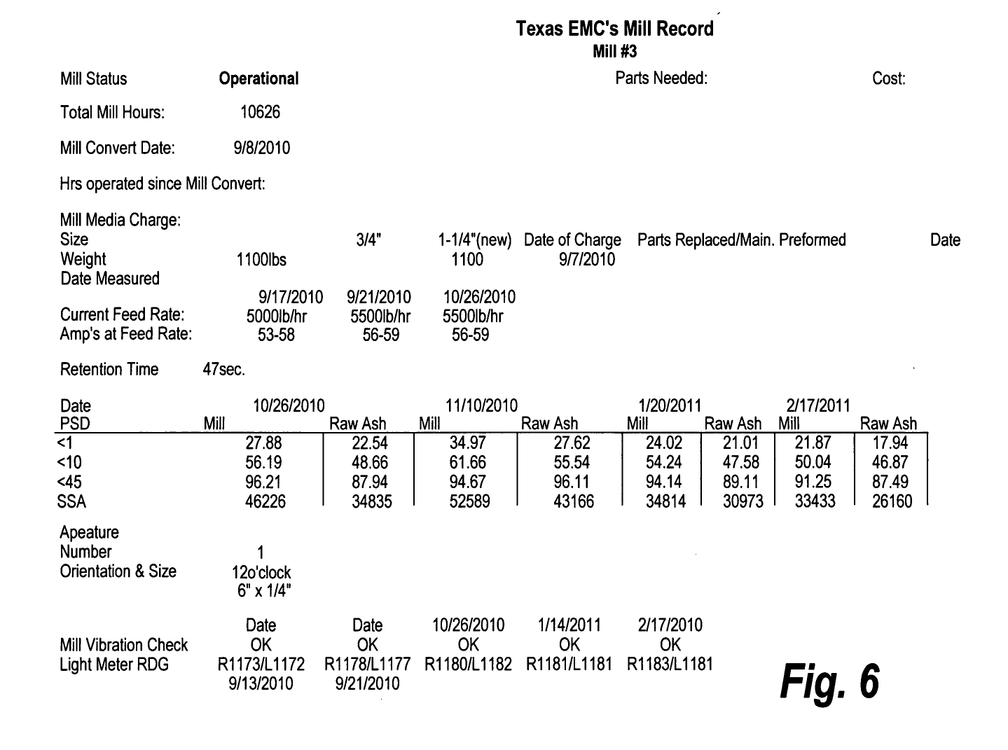

Referring to FIG. 6 for Mill 3, the mill media charge weight was 1100 pounds with a feed rate and amps as indicated, as well as the indicated particle size distribution. In this embodiment only a single slot was used at 6 inches long by one inch ¼ wide, with an SSA going from 34,835 to 46,226 in one test; 43,166 to 52,589 in another test and 30,973 to 34,814; and 26,160 to 33,433 for the fourth test. Here the retention time was 47 seconds with the specific surface area increased by as much as 20%.

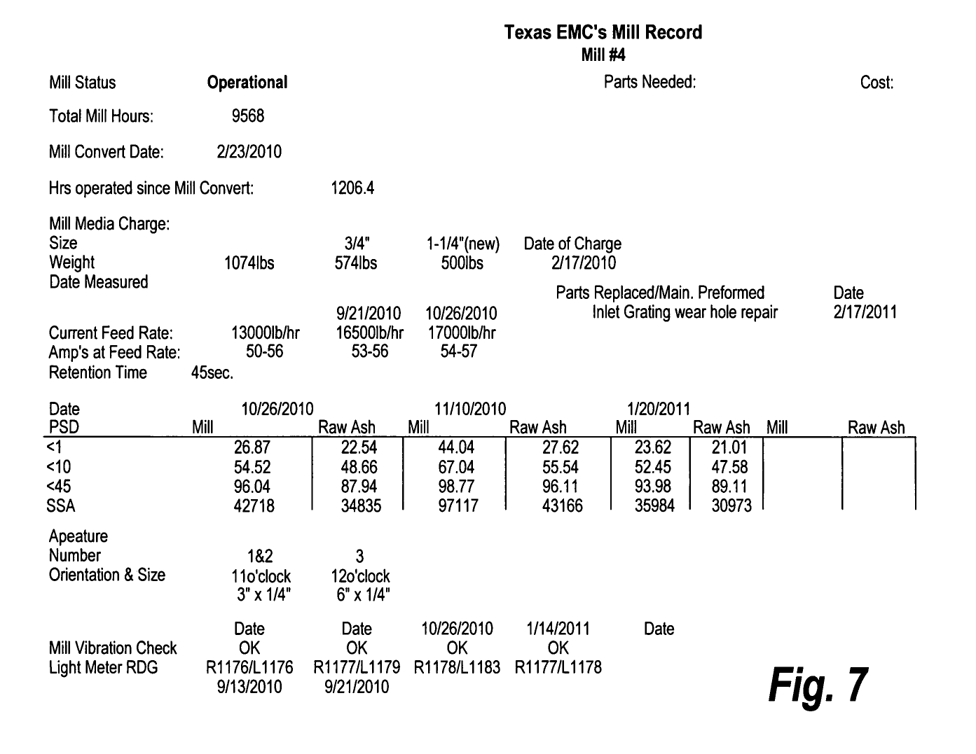

Referring to FIG. 7, in this test for Mill 4 the mill media charge weight was 1074 pounds with a feed rate of 13,000 pounds per hour to 17,000 with a retention time of 45 seconds. Here the slot configuration was one slot at 3 inches long by a ¼ inch width at the 11 o'clock position and one slot at the 12 o'clock position of 6 inches long and a ¼ inch width. In respective tests the SSA went from 34,835 to 40,718; 43,166 to 97,117 and 30,973 to 35,984.

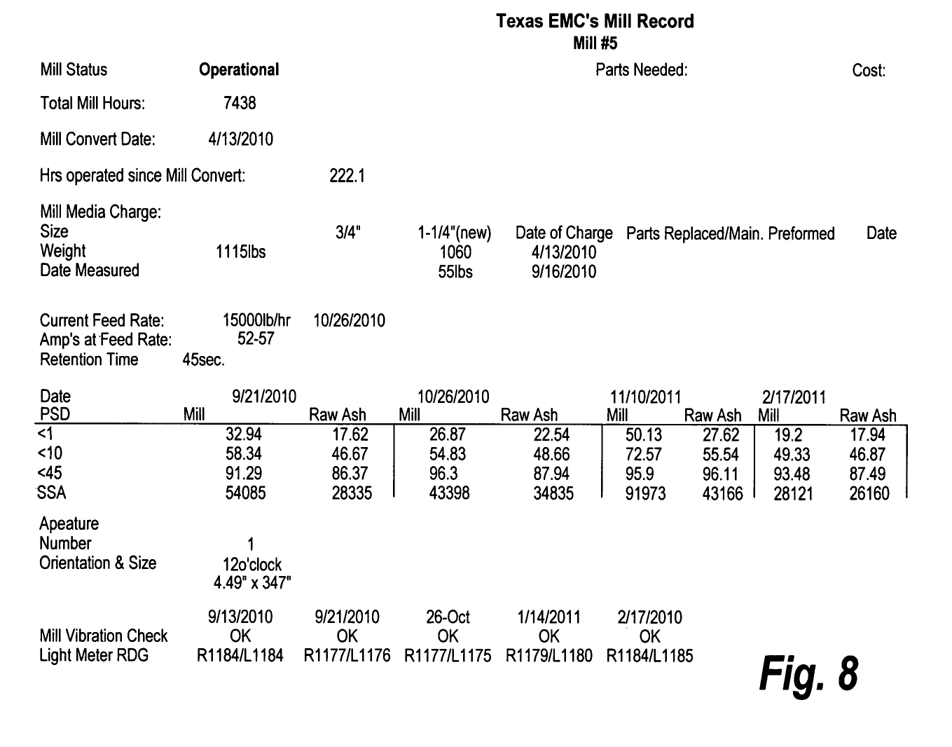

Referring to FIG. 8 for Mill 5, the mill media charge weight was 1,115 pounds, the feed rate was 15,000 pounds per hour with the particle size distribution as illustrated and with the single slot at the 12 o'clock position being 4.49 inches in length and 0.347 inches in width. Here the raw ash SSA went from 28,335 to 54,085; 34,835 to 43,398; 41,166 to 91,973; and 26,160 to 28,121.

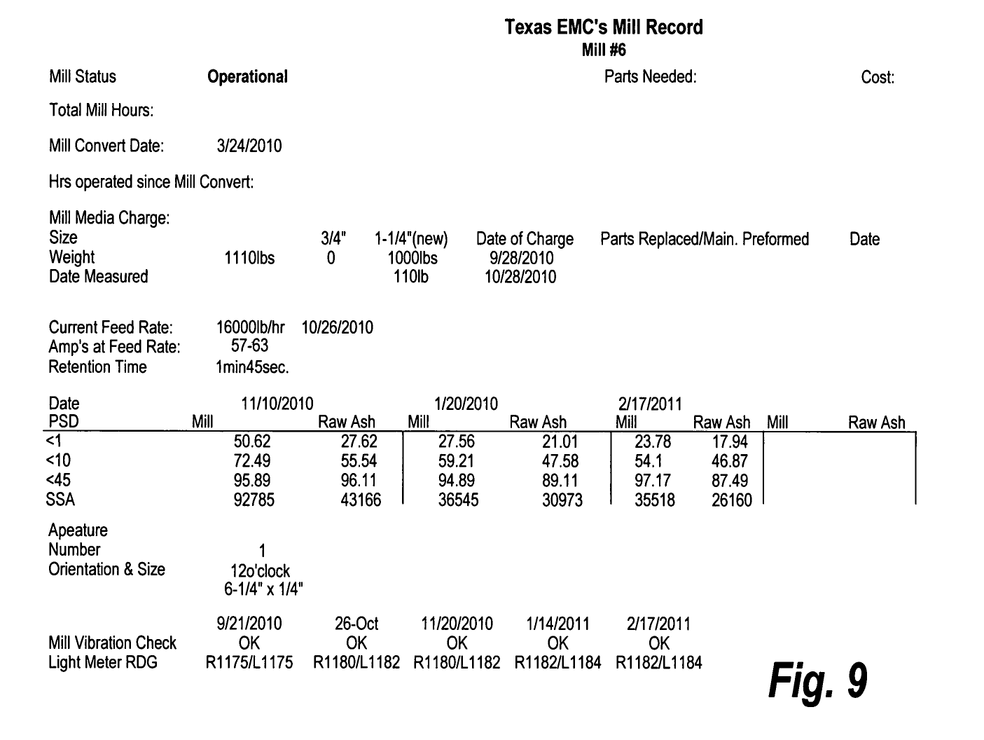

Finally, and referring now to FIG. 9, for Mill 6 the media mill charge weight was 1110 pounds, with the feed rate being 16,000 pounds per hour, with the indicated amps at the feed rate and a retention time a relatively long 1 minute 45 seconds. Here a single slot was used at 6 inches long and a ¼ inch width.

The particle size distributions are as illustrated, with the specific surface areas going from 43,166 to 92,785; 30,973 to 36,545 and 26,160 going to 35,518.

What can be seen is that the increase in specific surface area varies from batch to batch and operating conditions. However, what is clear is that the average increase in surface area is on the order of 20%, again as measured by a laser scattering particle size analyzer La 300.

What has been provided is a milling system in which the dwell time for the feedstock in the mill is dramatically increased, thereby providing finer and finer particles having concomitantly increased reactivity. When the resulting milled product is mixed with Portland cement, as much as a 50% cement replacement is possible with the attendant cost savings while maintaining the required strength of the concrete.

By modifying the traditional vibrating media mill to inject feedstock at the bottom, and by providing the media in the mill to be of a ceramic variety, and by providing an upper exit aperture or slot in the front discharge disk, one is able to more finely grind the feedstock to provide increased specific surface area for better reactivity, with the feedstock exiting at an upper aperture only after it has floated up to the upper aperture due to the fact of its decreased weight as a result of the finer grinding.

In addition, the use of water reducing admixes such as polycarboxylates and typical cement accelerators react in an enhanced manner given the increased surface area. These admixtures can be added once the material has been treated and give an improved result, increasing the strength and durability of the cementitious mix much greater than material not treated.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for increasing the surface area of a milled product, milled by a vibrating milling machine having a chamber in which media is stored, and a top loading feedstock port and a discharge grate having a number of apertures therethrough, comprising the steps of:
feeding the chamber with material to be milled at the base of the chamber; and,
replacing the discharge grate with a solid plate having at least one slot at the upper portion thereof such that the feedstock to be milled is not allowed to float to the top of the chamber but rather is introduced to the bottom of the chamber where it is subjected to the milling media for a large percentage of the time and such that the milled feedstock only exits the slot when it is light enough to rise to the top of the chamber, thereby increasing the dwell time in the chamber with the result of an increased surface area for the milled product.

2. The method of claim 1, wherein a single slot is provided for the solid plate at the 12 o'clock position.

3. The method of claim 2, wherein the single slot has a length of 6 inches and a width of ¼ inch.

4. The method of claim 1, and further including a pair of slots to either side of said 12 o'clock slot, one of said slots being at the 11 o'clock position and the other of the slots being at the 1 o'clock position.

5. The method of claim 4, wherein the slots at the 11 o'clock position and the 1 o'clock position are three inches in length and one ¼ inch in width.

6. The method of claim 1, and further including ceramic media in the chamber.

7. The method of claim 6, wherein the ceramic media is in the form of a cylinder.

8. The method of claim 1, wherein the feedstock is fly ash.

9. The method of claim 8, wherein the milled fly ash from the chamber is mixed with cement.

10. The method of claim 9, wherein the mixture of the milled fly ash to the cement is such that the milled fly ash constitutes 50% of the cementitious mixture.

11. The method of claim 1, wherein the feedstock includes one of fly ash and pozzolan.

12. The method of claim 1, wherein the dwell time of the feedstock in the chamber exceeds 5 seconds.

13. The method of claim 12, wherein the dwell time of the feedstock in the chamber exceeds 40 seconds.

14. The method of claim 1, wherein the dwell time of the feedstock in the chamber exceeds 1 minute.

15. The method of claim 1, wherein the surface area of the feedstock increases by at least 20%.

16. A vibrating media mill for the production of milled material used in the manufacture of concrete, comprising:
a vibrating media milling machine having a vibrating chamber and media therein, said vibrating chamber having a feedstock inlet port at the base thereof and having an apertured solid disk at the exit end of said chamber, said solid disk having at least one slot in the upper region thereof and an exit side; and,
a discharge pipe in communication with the exit side of said slotted disk.

17. The apparatus of claim 16, and further including a number of additional slots at the upper portion of said disk.

18. The apparatus of claim 17, wherein at least one of said additional slots is at the 11 o'clock position and in which another of said slots is at the 1 o'clock position.

19. The apparatus of claim 18, wherein the total size subtended by said slots is equivalent to a slot 9 inches long by one ¼ inch wide.

20. The apparatus of claim 16, wherein said at least one slot is 6 inches long by one ¼ inch wide.

21. The apparatus of claim 16, wherein the media in said chamber includes ceramic media.

22. The apparatus of claim 21, wherein said ceramic media is cylindrically shaped.

23. The apparatus of claim 22, wherein said media extends from the bottom of said chamber to the center of said chamber, thus to provide a large number of impacts of the feedstock with the media.

24. A method for manufacturing concrete, comprising the steps of:
grinding fly ash feedstock in a vibrating media mill at least partially filled with media in which the feedstock is introduced into the bottom of the mill chamber and in which the mill chamber is sealed at one end by a solid plate having a slot therein above the longitudinal center line of the chamber;
the chamber having a plenum formed by the slotted solid plate and a door, the chamber further including a discharge pipe communicating with the plenum; and,
mixing the milled fly ash with cement to provide a cementitious mixture useful in manufacturing concrete.

25. The method of claim 24, wherein the vibrating media mill includes ceramic media.

26. The method of claim 25, wherein the milled fly ash has a specific surface area that is greater than raw fly ash by at least 20%.
